(19) United States
(12) Patent Application Publication
(10) Pub. No.: US 2015/0373140 A1
(43) Pub. Date: Dec. 24, 2015

(54) CLIENT SIDE INITIATED CACHING CONTROL

(71) Applicants: Cisco Technology, Inc., San Jose, CA (US); NDS LIMITED, Staines, Middlesex (GB)

(72) Inventors: Arie HAENEL, Jerusalem (IL); Leonid SANDLER, Jerusalem (IL); Tomer AVITZUR, Yishuv Sansana (IL)

(21) Appl. No.: 14/410,571

(22) PCT Filed: Jun. 20, 2013
(86) PCT No.: PCT/IB2013/055068

§ 371 Date: Dec. 23, 2014

(30) Foreign Application Priority Data
Jun. 26, 2012 (GB) 1211319.9

(51) Int. Cl. H04L 29/08; H04L 9/32; H04L 29/06

(52) U.S. Cl. CPC H04L 67/2852; H04L 67/1097; H04L 63/08; H04L 9/3247; H04L 2209/72

(57) ABSTRACT

A method, system and related apparatus are described, the system comprising a caching-capable element which is part of a data network, which receives a request from a downstream client device, the request including a content request, the content request including a Universal Resource Identifier (URI) and an explicit caching request, the caching request includes a unique content identifier which is independent of the URI, and optional expiration date information, a comparator included at the caching-capable element which compares the caching request against the existing cached content, and if the requested content is cached then the caching-capable element forwards the cached copy of the requested content to the client device, and if the requested content is not cached, then the caching-capable element forwards the request to a further upstream device, and, upon reception of the requested content from the further upstream device, returns the requested content to the requesting downstream device, and caches the requested content for further distribution to other clients. Related methods, systems and apparatus are also described.

### FIELD OF THE INVENTION

The present invention relates to methods for delivering content to client devices, and more specifically, to requests and/or recommendations to cloud equipment to cache the requested content for later use by other clients.

### BACKGROUND OF THE INVENTION

As part of acquiring information from a server, clients issue URI requests corresponding for desired content. From the client perspective, the desired content arrives from the server. However, if all of the potential clients attempt to access the same server at more or less the same time, the server will very likely fail due to an overload. Therefore, servers utilize material caching mechanisms that exist in cloud equipment in order to distribute the load of client requests.

The term “cloud equipment” is understood to refer to caching-capable elements or entities (such as, and without limiting the generality of the foregoing, proxy caches) present in the data network (sometimes popularly referred to as “The Cloud”).

The HTTP protocol allows special header fields to contain a cache-control information and/or cache-control recommendations which are used by a source server to recommend the cloud equipment (such as servers at any and all ISPs that are involved in intermediating the requested content between the requesting client and the server) to cache the material contained in the corresponding HTTP packet in order to optimize the network traffic and serve subsequent client requests from the cache. It is understood that HTTP is one protocol, and other protocols, such as, and without limiting the generality of the foregoing, other protocols, such as proprietary protocols may also have similar features.

However, in some cases the caching recommendation information is not propagated adequately either due to technical limitations of the equipment or due to conflicting business interests of involved parties. The present invention is intended to mitigate this limitation.

It is also the case that sometimes in order to prevent caching, involved parties modify or personalize URI so that cloud equipment cannot recognize that two requests refer to the same material.

### SUMMARY OF THE INVENTION

The present invention, in certain embodiments thereof, seeks to provide an improved method enabling caching instructions to be sent to cloud equipment from the client side, thereby complementing or replacing the existing caching control mechanism that may be deactivated as described above. When caching control information is propagated from the client to the server side, it reaches all the cloud equipment that previously would not have receives this information due to its removal.

For example, and without limiting the generality of the foregoing, a server initiated caching recommendation, as it exist at present, might comprise the field in the HTTP header:
Cache control: max age=60, private.

In an embodiment of the present invention, a similar field would be added to the get content request from the client device.

There is thus provided in accordance with an embodiment of the present invention a system comprising a caching-capable element which is part of a data network, which receives a request from a downstream client device, the request including a content request, the content request including a Universal Resource Identifier (URI) and an explicit caching request, the caching request includes a unique content identifier which is independent of the URI, and optional expiration date information, a comparator included at the caching-capable element which compares the caching request against the existing cached content, and if the requested content is cached then the caching-capable element forwards the cached copy of the requested content to the client device, and if the requested content is not cached, then the caching-capable element forwards the request to a further upstream device, and, upon reception of the requested content from the further upstream device, returns the requested content to the requesting downstream device, and caches the requested content for further distribution to other clients.

Further in accordance with an embodiment of the present invention including a cryptographic engine which verifies one of a symmetric cryptographic digital signature or an asymmetric cryptographic digital signature to the caching request, and the caching-capable element only performs the caching operation if the caching request is properly signed, otherwise the caching-capable element either forwards the request to the further upstream device and does not perform the caching of the content, or denies the request as an invalid request.

Still further in accordance with an embodiment of the present invention the caching request refers only to certain part of the requested content.

Additionally in accordance with an embodiment of the present invention the content request as accompanied with digitally signed caching request as well as unique cryptographically protected and authenticated access control token confirming that this specific user device is authorized to access the requested content, in which case, the request will be refused if the client failed to present a properly signed access token.

There is also provided in accordance with another embodiment of the present invention a method including receiving a request from a downstream client device, at a caching-capable element which is part of a data network, the request including a content request, the content request including a Universal Resource Identifier (URI) and an explicit caching request, the caching request including a unique content identifier which is independent of the URI, and optional expiration date information, comparing at a comparator included at the caching-capable element which compares the caching request against the existing cached content, and if the requested content is cached then the caching-capable element forwards the cached copy of the requested content to the client device, and if the requested content is not cached, then the caching-capable element forwards the request to a further upstream device, and, upon reception of the requested content from the further upstream device, returns the requested content to the requesting downstream device, and caches the requested content for further distribution to other clients.

### BRIEF DESCRIPTION OF THE DRAWINGS

The present invention will be understood and appreciated more fully from the following detailed description, taken in conjunction with the drawings in which:

FIG. 1 is a simplified partially pictorial illustration of a typical network topology in which a system for client side recommended caching may be implemented;

FIG. 2 is a data flow diagram depicting a method for client side caching control in accordance with the system of FIG. 1; and

FIGS. 3 and 4 are flowchart diagrams of various embodiments of the methods of the system of FIG. 1, from the point of view of the cloud equipment.

### DETAILED DESCRIPTION OF AN EMBODIMENT

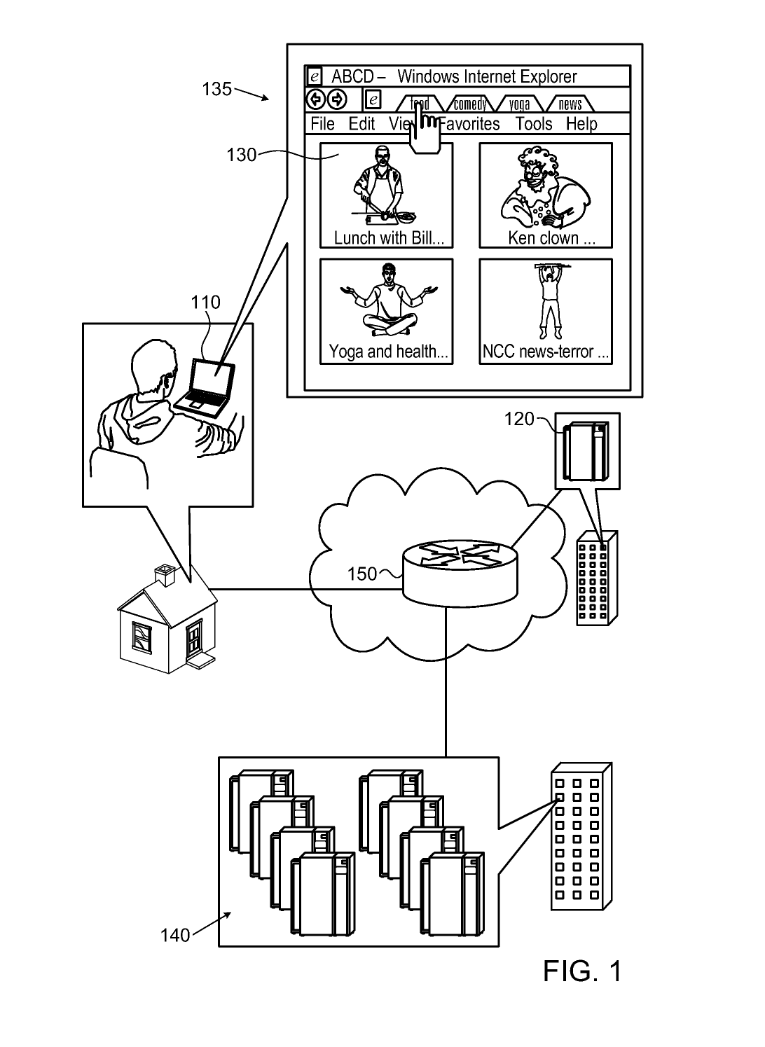

Reference is now made to FIG. 1, which is a simplified partially pictorial illustration of a typical network topology in which a system for client side recommended caching may be implemented. The system of FIG. 1 comprises a client device 110 in communication with a content server 140. The content server 140 provides the client device 110 with data, enabling the client device 110 to use the data in an application.

The client device 110 enables the user to interact with an application, depiction in FIG. 1 as a browsing application 135, which has links 130 enabling the user to access content. For example and without limiting the generality of the foregoing this content which can be accessed by clicking on the link 130 can be a news story; an image file; or a video clip, and so forth, to be displayed on the client device 110.

In this example, the client device may be a set top box, a personal video recorder, a handheld device (such as a smart phone or a tablet computer), a desktop or laptop computer, or any other appropriate client device 110.

The client device 110 is typically in contact with a server or portal 120 and the content server 140 via the Internet, and typically establishes a connection with the server or portal 120 and the content server 140 through cloud infrastructure 150. The cloud infrastructure typically comprises several intermediate servers, including but not limited to, at least one caching-capable element.

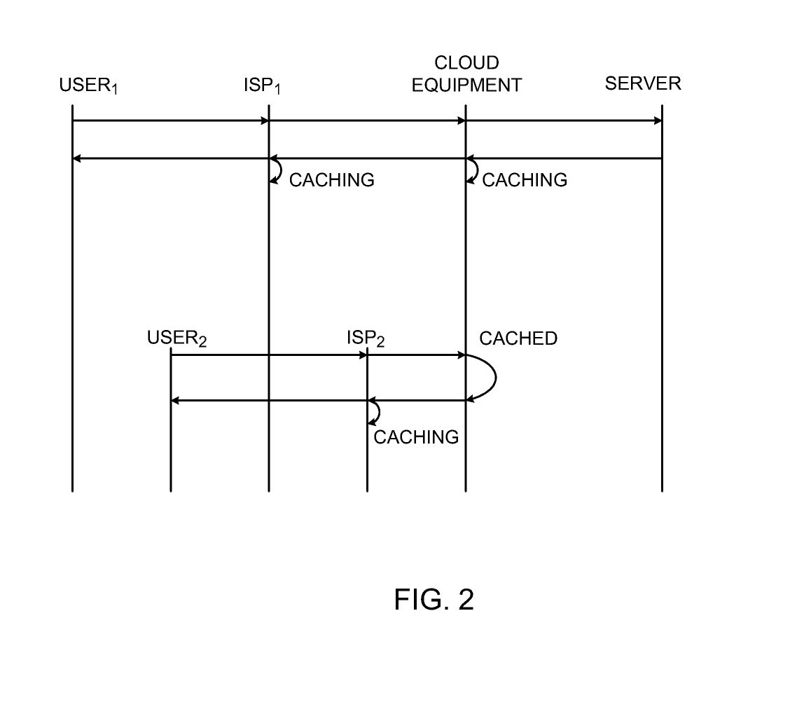

Reference is now made to FIG. 2, which is a data flow diagram depicting a method for client side caching control in accordance with the system of FIG. 1. In the discussion of FIG. 2, reference numbers refer to the elements depicted in FIG. 1.

The method of the system of FIG. 1 is invoked when the client device 110 sends a request for data (i.e. the content item) from the content server 140. However, in typical situations, the client device 110 does not communicate directly with the remote server 140 on which the requested content item is hosted, but rather, such communication is intermediated through ISP(s) (Internet Service Provider) and other cloud equipment.

When the client device 110 sends the request (i.e. referred to hereinafter as “the content request”) requesting the content from the content server 140, the content request comprises a request for the desired content item identified using a URI and an explicit caching request, the caching request comprises:
a unique content identifier which is independent of the URI; and
optional expiration date information (for instance an item might be given expiration date information based on a decision by the content provider as to when that item will no longer be in demand).

The unique content identifier which is independent of the URI is generated internally at the content provider. For example, if a first user clicks on a link to a particular news story, the content request generated as a result of the click will include the unique content identifier for that news story, as embedded by the content provider. A second user may click on a different link, apparently with a different URI, however, as the same news story is intended, the content provider will build the generated content request so that the unique content identifier is identical to that in the link clicked on by the first user.

When one of the intermediate devices between the client device 110 and the content server 140 receives the content request, a comparator comprised at the receiving intermediate device compares the caching request against the existing cached content. For example, and
If the requested content is cached then the intermediate device forwards the cached copy of the requested content to the requesting client device 110.
If the requested content is not cached, then the intermediate device forwards the request to a further upstream intermediate device, and, upon reception of the requested content from the further upstream device, the intermediate device returns the requested content to the requesting client device 110. The intermediate device then caches the requested content for further distribution to other client devices.

It is appreciated that since the intermediate device referred to above is a caching-capable element, the two terms “intermediate device” and “caching-capable element” may be used in the present specification and claims interchangeably.

The caching recommendation may further comprise at least one of:
content fragment information (i.e. information indicating that a fragment of data is subordinate to a larger data item used when client caching recommendation refers to a fragment of the content item); and
expiration date information.

The ISP 150 (depicted as ISP₁ in FIG. 2) receives the request and checks if the requested content item is cached at the ISP 150. If the requested content item is already cached at the ISP 150, then the ISP 150 sends the cached requested content item to the client device 110. An exemplary situation where the requested content item is cached at the ISP 150 is depicted where User₂ sends a request to ISP₂, and, since the requested content is already cached at some cloud equipment, the cached content is sent to ISP₂. ISP₂ then itself caches the requested content, and sends the requested content on to User₂.

If the requested content is not cached at the ISP₁, then the ISP₁ stores the request and forwards the request to the next network node (depicted in FIG. 2 as “cloud equipment”. As was noted above, the term “cloud equipment” is understood to refer to caching-capable elements (such a proxy caches) present in the data network). It is appreciated that the cloud equipment of FIG. 2 can be the content server 140 or any caching-capable element of the Cloud. The content server 140 sends the requested content item to the client device 110, and all intermediate cloud equipment (i.e. the network elements between the content server 140 and the client 110) have the possibility to cache the requested content item, including the ISP 150. Only in cases where no entity in the path from the client device 110 to the remote server 140 has cached the requested content item does the request reach the remote server 140. Otherwise, the client device 110 is sent the content item from one of the intermediary caches.

In the embodiment of the present invention described herein content caching is performed based on the client recommendation and not on the server recommendation, as it is done in the traditional internet environment. Therefore, if the server does not provide such a recommendation or if the server's recommendation is removed by the cloud equipment, then the content will still be cached.

It is appreciated that in order to protect the caching entity against a denial of service attack the caching recommendation may be cryptographically protected (e.g. digitally signed), by way of example, by a portal containing the content information and links to the remote content server 140) using any relevant cryptographic scheme. If the caching recommendation is properly signed, the cloud equipment will perform the caching. If the caching recommendation is not properly signed (for example, and without limiting the generality of the foregoing, if the signature is not valid), the request is forwarded to the content provider (i.e. the remote content server 140) or denied, depends on implementation decision.

For example and without limiting the generality of the foregoing the Portal 120 signs and sends the signed caching recommendation to the client device 110. The client device 110 sends this recommendation to the content provider, in this case, the content server 140. When the request arrives at the ISP 150, the ISP 150 validates the signature. If the requested content is already cached (see ISP₂, FIG. 2), the ISP 150 then returns the requested content item to the client device 110. If the signature is not properly verified, then the request is forwarded to the content provider, in this case, the remote farm of servers 140 or denied.

It is possible that content server owner wants to limit access to this content only to authorized users while still using the proposed caching mechanism. In such case, the requesting device must present a valid access token corresponding to the content identification in the caching recommendation in order for ISP 150 to return the cached content to the requester. This access token may be cryptographically protected by various methods (for example and without limiting, by a symmetric signature or, alternatively, PKI signature). Access tokens are used in content distribution systems at present. The novelty of the proposed method is in the fact that the access token to the content identification inside the caching recommendation rather than the content URI.

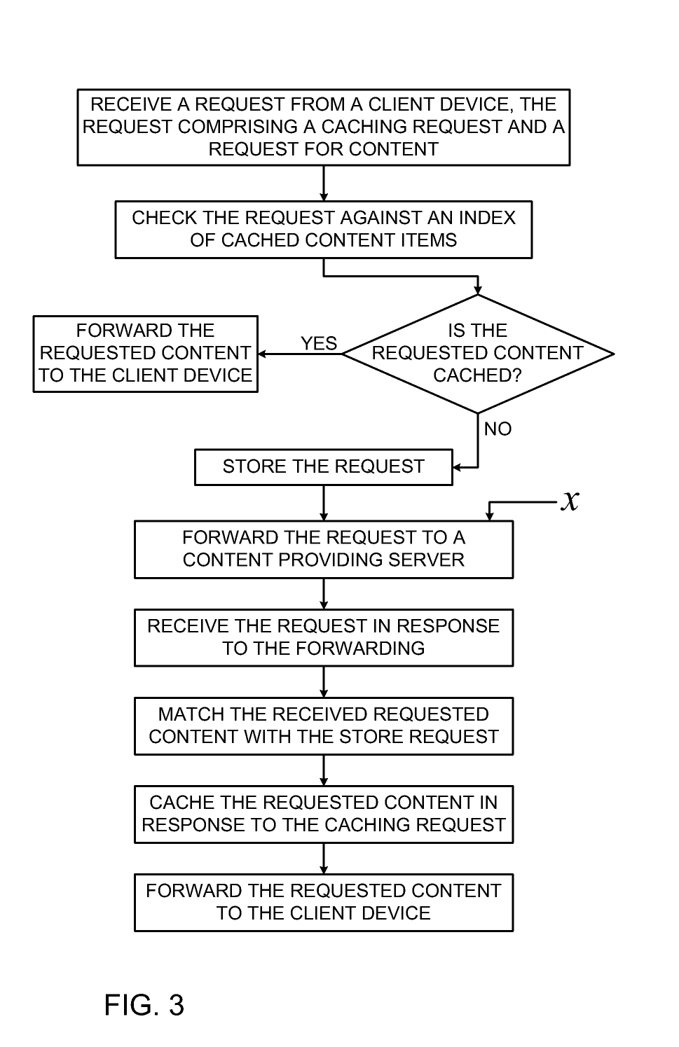

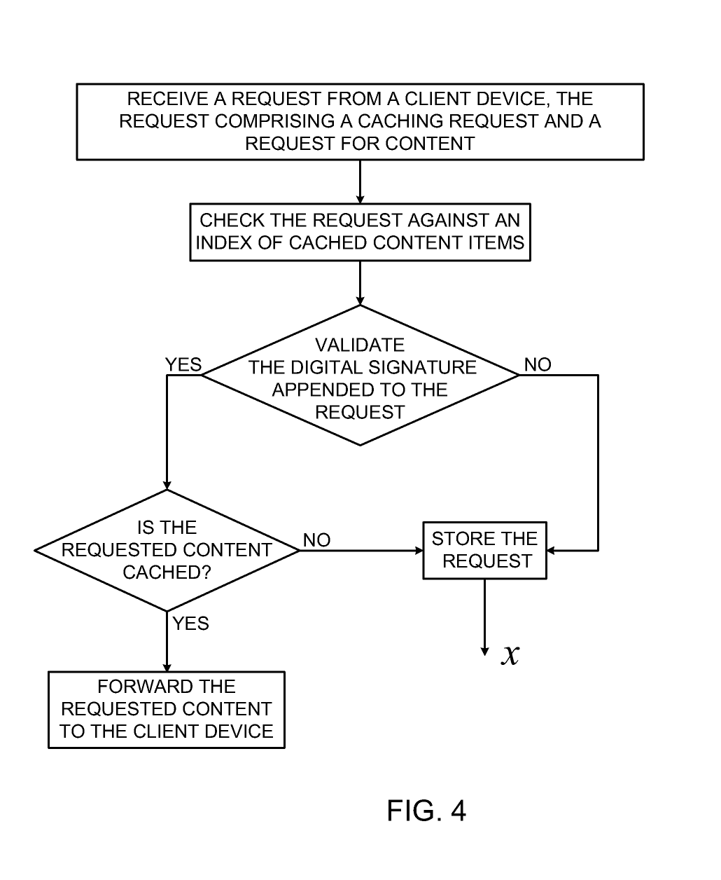

Reference is now made to FIGS. 3 and 4, which are flowchart diagrams of various embodiments of the methods of the system of FIG. 1, from the point of view of the cloud equipment. FIGS. 3 and 4 are believed to be self-explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1. A system comprising:
a caching-capable element which is part of a data network, which receives a request from a downstream client device, the request including a content request, the content request comprising a Universal Resource Identifier (URI) and an explicit caching request, the caching request comprises:
a unique content identifier which is independent of the URI; and
optional expiration date information;
a comparator comprised at the caching-capable element which compares the caching request against the existing cached content; and
if the requested content is cached then the caching-capable element forwards the cached copy of the requested content to the client device; and
if the requested content is not cached, then the caching-capable element forwards the request to a further upstream device, and, upon reception of the requested content from the further upstream device, returns the requested content to the requesting downstream device, and caches the requested content for further distribution to other clients.

2. The system according to claim 1 and further comprising:
a cryptographic engine which verifies one of a symmetric cryptographic digital signature or an asymmetric cryptographic digital signature to the caching request; and
the caching-capable element only performs the caching operation if the caching request is properly signed; otherwise
the caching-capable element either:
forwards the request to the further upstream device and does not perform the caching of the content; or
denies the request as an invalid request.

3. The system according to claim 1 wherein the caching request refers only to a certain part of the requested content.

4. The system according to claim 3 wherein the content request as accompanied with digitally signed caching request as well as unique cryptographically protected and authenticated access control token confirming that this specific user device is authorized to access the requested content, in which case, the request will be refused if the client failed to present a properly signed access token.

5. A method comprising:
receiving a request from a downstream client device, at a caching-capable element which is part of a data network, the request including a content request, the content request comprising a Universal Resource Identifier (URI) and an explicit caching request, the caching request comprising:
a unique content identifier which is independent of the URI; and
optional expiration date information;
comparing at a comparator comprised at the caching-capable element which compares the caching request against the existing cached content; and
if the requested content is cached then the caching-capable element forwards the cached copy of the requested content to the client device; and
if the requested content is not cached, then the caching-capable element forwards the request to a further upstream device, and, upon reception of the requested content from the further upstream device, returns the requested content to the requesting downstream device, and caches the requested content for further distribution to other clients.

6. The method according to claim 5 and further comprising:
verifying at a cryptographic engine one of a symmetric cryptographic digital signature or an asymmetric cryptographic digital signature to the caching request; and
performing the caching operation by the caching-capable element only if the caching request is properly signed; otherwise
the caching-capable element performs one of:
forwarding the request to the further upstream device and not performing the caching of the content; or
denying the request as an invalid request.

7. The method according to claim 5 wherein the caching request refers only to a certain part of the requested content.

8. The method according to claim 7 wherein the content request as accompanied with digitally signed caching request as well as unique cryptographically protected and authenticated access control token confirming that this specific user device is authorized to access the requested content, in which case, the request will be refused if the client failed to present a properly signed access token.
